(19) United States
(12) Patent Application Publication
(10) Pub. No.: US 2021/0276175 A1
(43) Pub. Date: Sep. 9, 2021

(54) BROKEN LIGHT BULB EXTRACTOR, LIGHT BULB CHANGER AND ANTI-LOOSENING POLE ADAPTER

(71) Applicant: LAWRENCE KRATISH, PANAMA CITY, FL (US)

(72) Inventor: LAWRENCE KRATISH, PANAMA CITY, FL (US)

(21) Appl. No.: 17/328,557

(22) Filed: May 24, 2021

Related U.S. Application Data
(63) Continuation-in-part of application No. 16/657,350, filed on Oct. 18, 2019.

(51) Int. Cl. B25G 3/30; B25G 1/04; B25B 27/14; F21V 21/36

(52) U.S. Cl. CPC B25G 3/30; F21V 21/36; B25B 27/14; B25G 1/043

(57) ABSTRACT

A light bulb remover extracts a broken light bulb from a socket of a high-hat light fixture. The light bulb remover has an extension pole and an extractor head attached to the extension pole. An anti-loosening adapter may be provided to securely connect the extractor head to the extension pole, such that rotation of the pole while extracting the bulb will prevent the extractor head from loosening from the extension pole. Such an adapter is configured to adapt between a right-handed thread on one of the extension pole and extractor head, and a left-handed thread on the other of the extension pole and extractor head. The extractor head has a guide which defines an outer circumference of the extractor head and a bulb extractor configured for engaging in a base of the broken light bulb and creating a friction connection with the base of the light bulb.

### CROSS-REFERENCE TO RELATED APPLICATIONS

The present application is a continuation-in-part of co-pending U.S. patent application Ser. No. 16/657,350, filed on Oct. 18, 2019, entitled Broken Light Bulb Extractor and Light Bulb Changer, that application being incorporated herein, by reference, in its entirety.

### BACKGROUND OF THE INVENTION

### Field of the Invention

The invention relates, generally, to a light bulb extractor for removing and replacing light bulbs from a light bulb socket and is especially configured for removing broken light bulbs from high-hat light fixtures disposed in a ceiling. An anti-loosening pole adapter is provided for preventing the light bulb extractor from unscrewing from a pole while the light bulb is extracted.

A typical residential or commercial lighting device consists of a socket that holds a replaceable light bulb threaded into the socket. Such lighting devices require replaceable light bulbs that have different sizes and/or shapes which vary depending on a number of different factors. The different sizes and/or shapes of the light bulbs can become problematic during routine replacement of the bulbs, particularly when the location of the socket is in an elevated location such as on a wall or a ceiling. Particular difficulties occur with a type of light known as a high-hat light fixture which is a light that is recessed into a ceiling where the ceiling may be 15-20 feet high in relation to the ground floor. In addition, should the bulb's glass casing have shattered, the difficulty of extracting the light bulb has increased exponentially.

A number of different prior art devices have been proposed to accommodate different light bulbs of different sizes and shapes. Generally these devices include a bulb gripper on an extension pole, where the bulb gripper can grip or hold a bulb with a gripping force such that rotation of the extension pole applies a rotational force to the bulb so that the bulb is threadably secured to and/or unsecured from a light socket. As used herein the term “gripping force” refers to the force applied by the device to temporarily hold the bulb in a desired position before/after/during installation, while the term rotational force refers to the application of torque to the bulb during installation/removal.

U.S. patent publication No. 2018/0308654 to Harrington et al. teaches such a light bulb replacement device. Harrington teaches that a top region of the handle is widened and holds multiple sized holding devices for holding and removing various sized bulb. In addition, the top region is provided with teeth for assisting in removing a broken bulb and has a catch or widened region for catching broken glass.

U.S. patent publication No. 2012/0247285 to Eyre teaches a utility grip for extracting broken glass bulbs. The utility grip either has a tip or a flared opening for engaging into a broken light bulb so that an appropriate rotational force can be applied to the light bulb for removing the light bulb. The utility grip is configured for receiving an extension pole so that the utility grip may be used for removing light bulbs in a high ceiling.

U.S. Pat. No. 1,319,028 to Grinnell discloses a device for removing broken light bulbs. The device has a tubular structure with a head disposed at one end of the tubular structure. The head has a plurality of angled clutch members for engaging in a base of a light bulb. The head has a reaming member for crushing remaining or interfering glass so that the angled clutch members can engage in the metal base of the light bulb so that a rotational force can be applied for removing the light bulb.

A problem with removing a broken light bulb from a high-hat light fixture, which is disposed 15-20 feet above the floor, is that centering of the bulb base engaging member becomes difficult as the weight of the light bulb removing device causes an individual to shake/sway the light bulb removing device as he/she extends the light bulb removing device toward the broken light bulb. The shaking/swaying of the light bulb removing device increases as the light bulb removing device is extended further away from the individual holding the light bulb extending device. There is a need for a self-centering device which once engaged inside of the high-hat light fixture self-centers the bulb base engaging device into the broken bulb base.

Additionally, U.S. Pat. No. 9,070,544 to Shaps et al., discloses a light bulb installation and removal tool including one or more attachment heads that are connected to an optional pole using interlocking threads (e.g., external male threads on the pole that cooperate with internal female threads of a handle of the attachment head). There is a need, however, for an adapter that reduces the chances of an attachment head becoming loose on, or falling off of, a threaded pole, during pole rotation when removing a light bulb.

### SUMMARY OF THE INVENTION

It is accordingly an object of the invention to provide a broken light bulb extractor and a light bulb changer that overcome the herein-mentioned disadvantages of the heretofore-known devices of this general type, which is configured to self-center itself and align with the base of a broken light bulbs housed in a high-hat light fixture, and/or which will not be loosened on an extension pole during pole rotation.

With the foregoing and other objects in view there is provided, in accordance with one embodiment of the invention, a light bulb remover for extracting a broken light bulb from a socket of a high-hat light fixture. The light bulb remover has an extension pole with first and second ends and an extractor head attached to the extension pole. The extractor head has a guide which defines an outer circumference of the extractor head. The extractor head has a bulb extractor configured for engaging in a base of the broken light bulb and creates a friction connection with the base of the light bulb. The bulb extractor is surrounded by the guide, and the guide has a diameter being less than a diameter of the high-hat light fixture and dimensioned so that when the light bulb remover is disposed within the high-hat light fixture the bulb extractor is self-aligned with a middle area of the base of the broken light bulb.

In accordance with an embodiment of the invention, the guide is cylindrically shaped and completely surrounds the light bulb extractor. Because of the snug fit and cylindrical shape of the light bulb remover, the bulb extractor is automatically centered in the base of the broken light bulb which assists in removal of the broken light bulb as the user merely has to apply pressure (e.g. push) upward towards the high-hat light fixture.

In accordance with another embodiment of the invention, the bulb extractor has a plurality of blades and a point of intersection of the blades defines a tip for jabbing into the base of the broken light bulb.

In accordance with one embodiment of the invention, each of the blades has a first end tapering towards the second end, and the tip is formed where the second ends of the blades meet. Because the blades are tapered they can fit into various sized light bulbs and only one bulb extractor is necessary for variously sized light bulbs.

In accordance with an additional embodiment of the invention, the extractor head has a circularly shaped bottom.

In accordance with still another embodiment of the invention, each of the blades has a lower portion and an upper portion. The lower portion extends up from the circularly shaped bottom, and the upper portion has a first side extending from the lower portion and a second side defining the tip. Ideally, the upper portion is formed from a softer material than the lower portion. In this manner the tip of the extractor head can be squished into the base of the light bulb creating a greater frictional fit between the tip and the base and thus making it easier to extract a broken light bulb.

In accordance with a further embodiment of the invention, the first end of the extension pole is a threaded first end and the circularly shaped bottom of the extractor head has a threaded central core for engaging with the threaded first end of the extension pole.

In accordance with another embodiment of the invention, the extension pole is a telescopic extension pole. Therefore, the user can adjust the length of the extension pole as desired.

In accordance with one embodiment of the invention, an adapter is provided for use between the threaded end of the extension pole and a threaded central core of the extractor head. More particularly, in the present embodiment, the adapter is a separate part that has at one end a female thread and, at the other end, a male thread. In the present preferred embodiment, the adapter is an anti-loosening pole adapter configured to oppose loosening of the extractor head from the extension pole. To this end, in one particular embodiment of the invention, the thread directions for the male thread of the adapter and the female thread of the adapter are opposite to one another. For example, if the male thread is a left-handed thread (running counterclockwise), the female thread is a right-handed thread (running clockwise). In this manner, when connected between the extension pole and the extractor head, the adapter will prevent the extractor head from loosening or becoming unscrewed from the extension pole when the pole is rotated to extract the bulb.

In accordance with yet another embodiment of the invention, the guide is disposed distally from the bulb extractor and forms a pocket for receiving broken glass from the broken light bulb. In this manner, the guide prevents glass from falling down and injuring the user.

In accordance with still another embodiment of the invention, the bulb extractor extends vertically from the circularly shaped bottom and has a first height, and the guide extends vertically from the circularly shaped bottom and has a second height, wherein the first height is greater than the second height.

In accordance with another embodiment of the invention, the diameter of the guide is within ¼-¾ inch of the diameter of the high-hat light fixture. The difference in diameter is chosen so that once the light bulb remover fits inside the high-hat light fixture the tip of the bulb extractor is aligned generally in the central area of the base of the bulb. In this manner the tip is always automatically aligned with the base as the guide is always in close engagement with the walls of the high-hat light fixture.

With the foregoing and other objects in view there is further provided, in accordance with the invention, a light bulb replacing system for replacing a light bulb from a high-hat light fixture. The light bulb replacing system includes an extension pole having first and second ends, a bulb attachment head connected to the extension pole and has first and second sides, an optional anti-loosening pipe adapter and a double-sided ring. The double-sided ring has a first side adhesively attached to the second side of the bulb attachment head and a second side with an adhesive layer for attaching to the light bulb to be replaced.

In accordance with an added embodiment of the invention, the first end of the extension pole is a threaded first end and the bulb attachment head has a circular base plate and a threaded cylindrical core extending from the circular base plate. In one embodiment, the threaded cylindrical core engages with the threaded first end of the extension pole. In another embodiment, the threaded cylindrical core engages a male thread of an anti-loosening pole adapter of the system, while a female thread of the anti-loosening pole adapter engages the threaded first end of the extension pole. In a particular embodiment, the male thread of the adapter is a left-handed thread, while the female thread of the adapter is a right-handed thread, and the adapter prevents the extractor head from becoming loose on the extension pole when the pole is rotated to remove a light bulb.

In accordance with a concomitant feature of one embodiment of the invention, an extractor head is attached to the second side of the double-sided ring. The extractor head has a guide defining an outer circumference of the extractor head. The extractor head has a bulb extractor configured for engaging in a base of a broken light bulb and creates a frictional connection with the base of the broken light bulb. The bulb extractor is surrounded by the guide and the guide has a diameter being less than a diameter of the high-hat light fixture. The guide is dimensioned so that when the light bulb replacing system is disposed within the high-hat light fixture the bulb extractor is self-aligned with a middle area of the base of the broken light bulb.

Other characteristic features of the invention are set forth in the appended claims.

Although the invention is illustrated and described herein as embodied in a broken light bulb extractor, a light bulb changer and an anti-loosening pole adapter, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is an illustration of a light bulb extractor and/or replacing device for installing a new light bulb in a high-hat light fixture;

FIG. 2 is perspective view of the light bulb extractor and/or replacement device;

FIG. 3 is an exploded, perspective view of the light bulb extractor and/or replacement device;

FIG. 4 is a perspective view of a first embodiment of the light bulb extractor head;

FIG. 5 is a top view of a second embodiment of the light bulb extractor head;

FIG. 6 is a partially exploded, side view of the second embodiment of the light bulb extractor head;

FIG. 7 is a sectional view of the light bulb extractor head with the addition of teeth;

FIG. 8 is a side view of the light bulb replacement unit;

FIG. 9 is a sectional view of the light bulb replacement unit;

FIG. 10 is a rear view of the light bulb replacement unit;

FIG. 11A is an exploded, perspective view of a light bulb extractor and/or replacement device in accordance with another embodiment of the invention;

FIG. 11B is an exploded, perspective view of a light bulb extractor and/or replacement device in accordance with a further embodiment of the invention;

FIG. 12 is a side plan view of an anti-loosening pole adapter in accordance with one particular embodiment of the invention;

FIG. 12A is a sectional view of the anti-loosening pole adapter of

FIG. 12, shown along the cutting plane denoted by cutting plane line A;

FIG. 13 is a bottom plan view of the anti-loosening pole adapter of FIG. 12; and

FIG. 14 is perspective view of an anti-loosening pole adapter in accordance with one particular embodiment of the invention.

### DETAILED DESCRIPTION OF THE INVENTION

In all the figures of the drawing, sub-features and integral parts that correspond to one another bear the same reference symbol in each case.

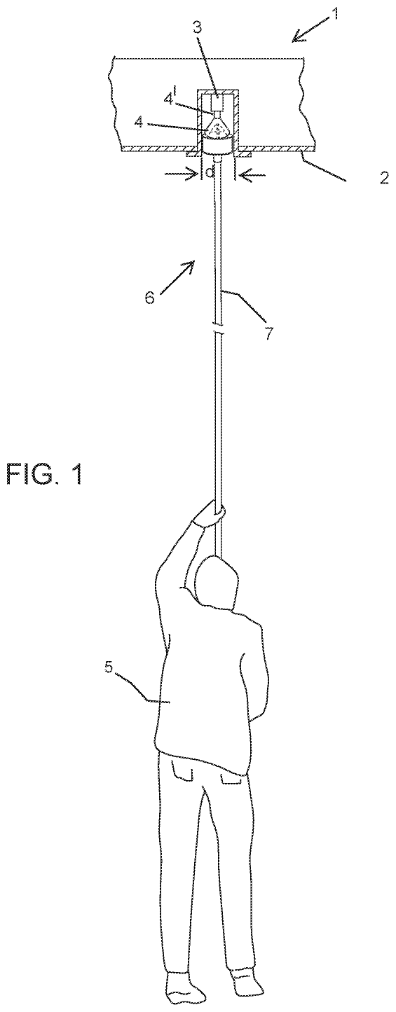

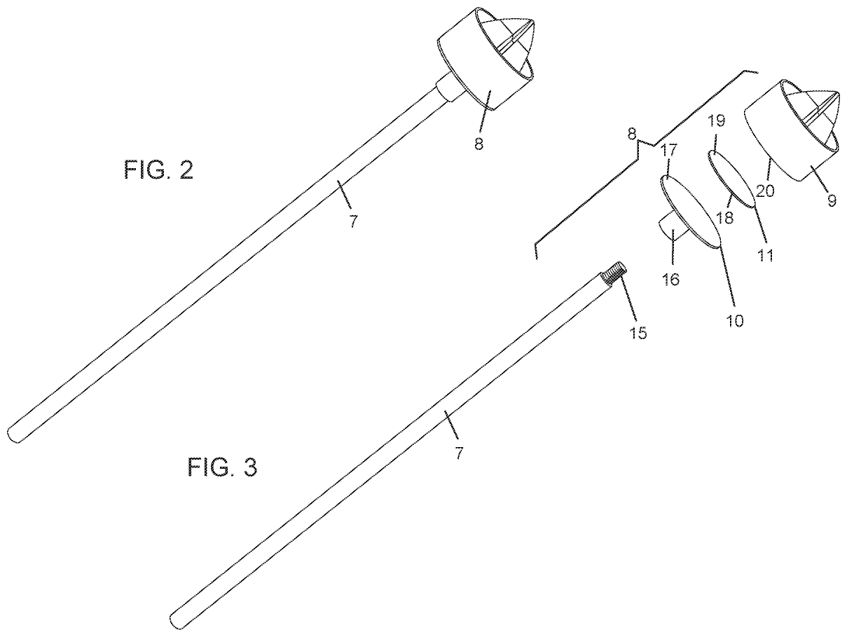

Referring now to the figures of the drawings in detail and first, particularly, to FIGS. 1 and 2 thereof, there is shown a high-hat light fixture 1 disposed or formed in a ceiling 2 and having a light bulb socket 3 holding a base 4′ of a light bulb 4. A user 5 is holding a light bulb removing and/or replacing device 6, hereinafter it shall be called a bulb extractor device 6. The bulb extractor device 6 has an extension pole 7 and a bulb removal/replacement head 8. The extension pole 7 is cylindrical in shape and can be a single-piece pole or a telescopic pole depending on the height requirements needed for accessing the light bulb 4.

FIGS. 2 and 3 show a first embodiment of the bulb extractor device 6 with a shortened version of the extension pole 7 as the pole length cannot fit into the page limitation. FIG. 3 shows an exploded view of the bulb extractor device 6 with special attention to the bulb removal/replacement head 8. The bulb removal/replacement head 8 is formed of three main components, including an extractor head 9, a bulb attachment head 10 and a double-sided adhesive ring 11. The extension pole 7 has a first threaded end 15 which engages with or into a first threaded end 16 of the bulb attachment head 10. The first threaded end 16 although shown to be cylindrical in shape may be any shape that is capable of bearing the threading for receiving and securing to the extension pole 7. In one particular embodiment of the invention, the first threaded end 16 is a female, right-handed thread configured to mate with the first threaded end 15, which, in that embodiment, is a male, right-handed thread. A first side 18 of the double-sided adhesive ring 11 attaches to a second, flat and circular end 17 of the bulb attachment head 10 with an adhesive fit (e.g. the double-sided adhesive ring 11 has an adhesive layer on both of its sides 18, 19). A second side 19 of the double-sided adhesive ring 11 attaches to a bottom or first side 20 of the extractor head 9. In this manner the double-sided adhesive ring 11 attaches and holds the extractor head 9 to the bulb attachment head 10 by an adhesive connection.

By configuring the bulb extractor device 6 with the bulb attachment head 10, the double-sided adhesive ring 11 and the attached extractor head 9, the bulb extractor device 6 is configured for replacing a broken light bulb 4 residing in the high-hat light fixture 1.

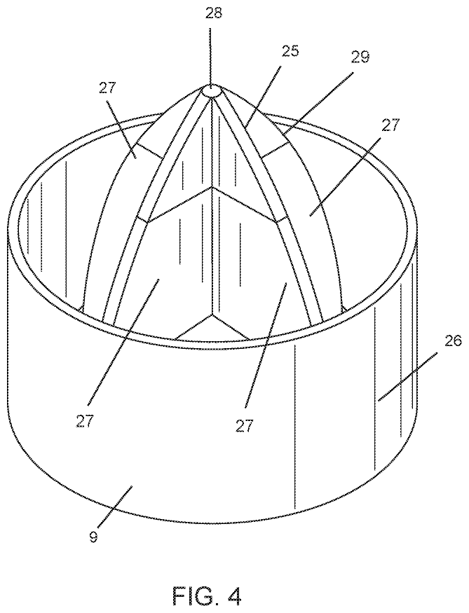

FIGS. 4-7 show different views and embodiments of the extractor head 9.

FIG. 4 is a perspective view of a first embodiment of the extractor head 9 having a bulb extractor 25 surrounded by a guide 26. The guide 26 is cylindrically shaped and configured for nestling directly in the high hat-light fixture 1 with little play (e.g. the guide 26 has almost the same dimensions as an opening to the high-hat light fixture). More specifically a diameter D of the guide 26 is within ¼-1 inch, ideally ½ inch, of a diameter d of the high-hat light fixture 1. Because of the little play between the circumference of the guide 26 and the walls of the high-hat light fixture 1, a self-centering of the extractor head 9 in the high-hat light fixture 1 is accomplished.

The bulb extractor 25 is formed of four (4) blades 27 disposed at 90° intervals (e.g. 3, 5, 6 or 8 blades are also feasible). The four blades 27 meet at a center point 28 which defines a digging point or tip 28 for digging into a base of the broken light bulb 4. Each blade 27 is formed with a curved shape or arching taper 29 as best shown in FIGS. 4 and 7. Ideally, the curved shape or arching taper 29 of each of the blades 27 allows the bulb extractor 25 to fit into various sized bulbs by further extending into the base of the broken light bulb 4. Two of the blades 27 form a half oval and the bulb extractor 25 is formed from two intersecting half ovals. Furthermore, in a modified embodiment of the extractor head 9, the blades 27 have a teething or roughing 40 which provide a greater frictional engagement with the base of the light bulb 4, see FIG. 7. Please note that in FIG. 7 the teething or roughening 40 is exaggerated.

The blades 27 can be formed from various materials which each have their own advantages and disadvantages. More specifically, the blades 27 can be formed completely from a hard plastic. In this manner the digging tip 28 can penetrate deeply into the base 4′ of the broken light bulb 4. A rotational force and a pushing force is applied to the extension pole 7 and the broken light bulb 4 is loosened in the light socket 3 and removed. However, due to the use of a hard plastic, frictional forces are reduced and slippage between the bulb extractor 25 and the broken light bulb 4 may occur upon turning of the extension pole 7.

In a second alternative embodiment, the blades 27 can be formed from a more elastic material. In this manner, the digging tip 28 can be squished into the base 4′ of the broken light bulb 4 and has a more frictional engagement with the base 4′ of the broken light bulb 4 for removing the broken light bulb 4. Furthermore, such an elastic tip 28 can deform to fit into various sized bases of the broken light bulb 4.

In a third embodiment, a bottom base 31 of the blades 27 is formed of a harder plastic and an upper section 32 is formed of a more flexible plastic or rubber, see FIG. 6. In this configuration, the hard plastic provides a stronger overall structure of the extractor head 9 and at the same time provides an elastic tip 28 for digging into the base 4′ of the broken light bulb 4 and creating a greater frictional engagement with the light bulb 4.

In all three embodiments the guide 26 forms a pocket 34 into which broken glass can be collected and centers the tip 28 for engaging into the base 4′ of any sized light bulb 4 that fits in the respective high-hat light fixture 1. The guide 26 has a height H that ideally extends approximately half way up a height h of the blades 27 which provides adequate centering ability and a deep enough pocket 34 for collecting sizable glass pieces that may break off. In addition, the guide 26 can be made of either a hard plastic or a flexible material as with the blades 27.

FIGS. 6 and 7 show a further refinement of the extractor head 9. The bottom side 20 of the extractor head 9 is configured with a threading 33 and can engage directly with the threading 15 of the extension pole 7 and therefore the bulb attachment head 10 and the double-side adhesive ring 11 are not necessary. As shown in FIGS. 6 and 7, the threading 33 is formed in a cylindrical body 35 which extends into the pocket 34 and around which the blades 27 are attached to and extend from.

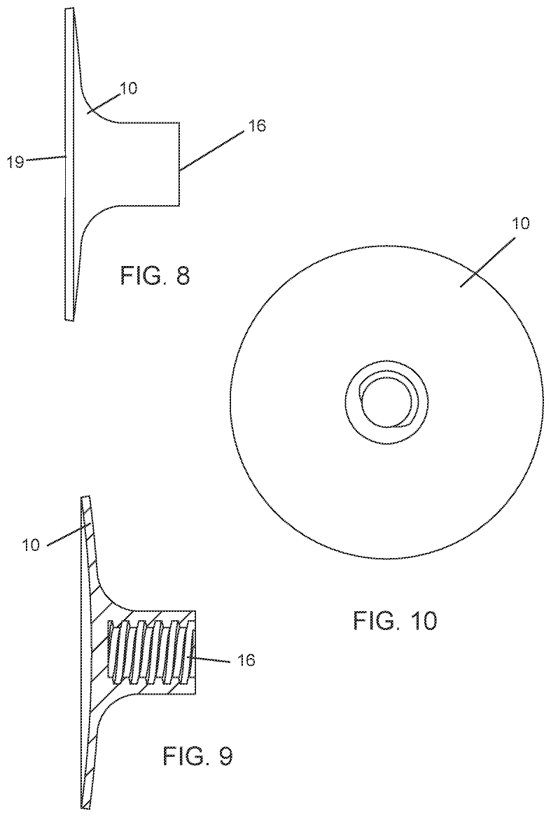

By configuring the extractor device 6 with only the bulb attachment head 10 and the adhesive ring 11 (e.g. without the extractor head 9), the bulb extractor device 6 is configured for replacing an unbroken bulb 4 in the high-hat light fixture 1. As shown in FIGS. 8-10, the bulb attachment head 10 is ideally circular in shape and has a diameter being approximately equal to that of a front face of a light bulb 4 to be removed, albeit slightly smaller. The exposed adhesive side 19 of the double-sided adhesive ring 11 is raised and placed in front of a front face of the light bulb 4 to be replaced. Then the adhesive side 19 is pressed on the front face of the light bulb 4. A rotational force is now applied to the extension pole 7 and the light bulb 4 is removed from the light socket 3. The extension pole 7 is lowered and old light bulb is pulled off of the double-sided adhesive ring 11. A new light bulb is attached to the double-sided adhesive ring 11 and the extension pole 7 is raised so that the new light bulb 4 can be screwed into the light socket 3. At this point a quick snap or pull of the extension pole 7 releases the adhesive bond between the double-sided adhesive ring 11 and new light bulb secured in the light socket 3.

In essence, the bulb extractor device 6 is configured for replacing undamaged burned out light bulbs and damaged light bulbs. The bulb extractor device 6 is ideally formed to remove broken light bulbs fitted in high-hat light fixtures 1 as it automatically centers the bulb extractor in the base of the damaged light bulb.

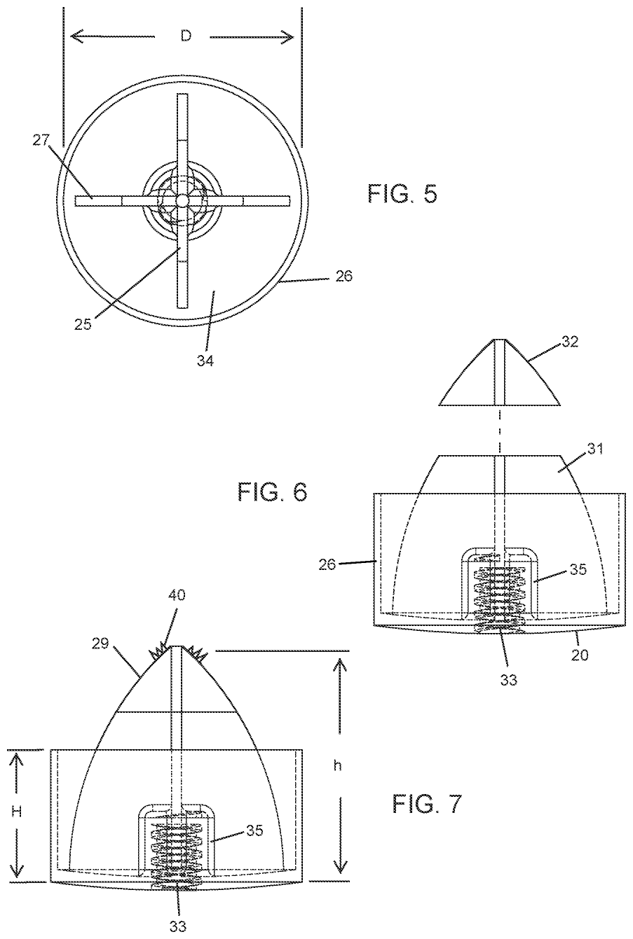

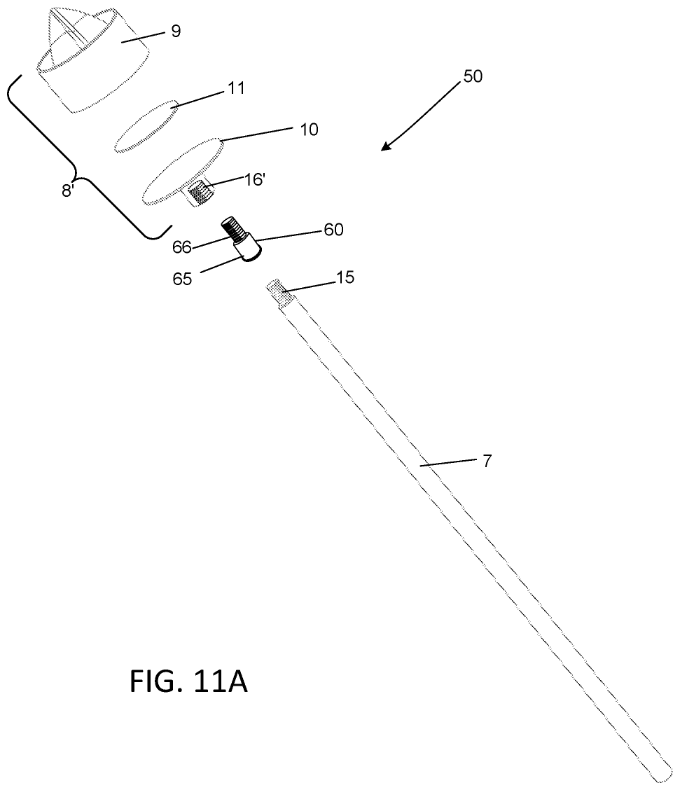

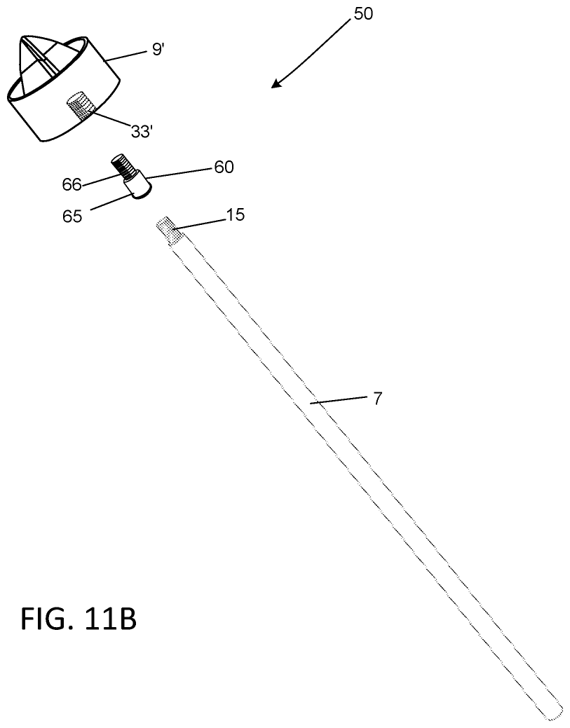

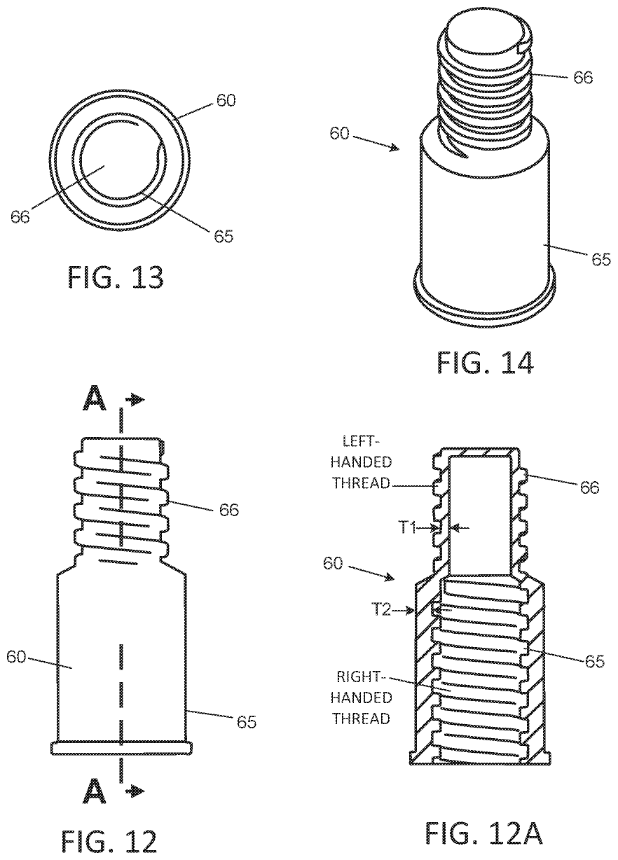

Referring now to FIGS. 11A-14, there will be described a bulb extractor system 50 in accordance with another embodiment of the invention. The bulb extractor system 50 includes a bulb removal/replacement head 8′ (FIG. 11A) or 9′ (FIG. 11 B), a threaded extension pole 7 and an anti-loosening pole adapter 60 disposed between the bulb removal/replacement head 8′ or 9′ and the threaded extension pole 7. Although bulb removal/replacement heads 8′, 9′ are illustrated as being substantially identical to the bulb removal/replacement head 8 of FIG. 3 and the extractor head 9 of FIGS. 5 - 7, respectively, this is not meant to be limiting, as other types of bulb removal/replacement and/or extractor heads may be used with the adapter 60 and pole 7 without departing from the scope or spirit of the current invention. However, for purposes of explanation, and in order to disclose a preferred embodiment, the bulb extractor system 50 will be described as using the bulb removal/replacement heads 8′, 9′, herein.

Like the, the bulb removal/replacement head 8, bulb removal/replacement head 8′ of FIG. 11A includes a first threaded end 16′ at the distal end of the bulb attachment head 10 and the extension pole 7 includes a first threaded end 15. Similarly, as with the extractor head 9 of FIGS. 5-7, the bottom side 20 of the bulb removal/replacement head 9′ of FIG. 11B includes a threading 33′. However, in the present embodiment, whereas the first threaded end 15 is a right-handed thread (i.e., a clockwise thread), the first threaded ends 16′, 33′ are female, left-handed threads (i.e., a reverse or counterclockwise thread). As such, when they are attached to one another (via the adapter 60) rotation of the pole 7 to remove a bulb will work to tighten the bulb removal/replacement heads 8′, 9′ onto the extension pole 7, rather than loosen the bulb removal/replacement heads 8′, 9′ from the extension pole 7.

Because of the different handedness of the threads 15 and 16′, 33′ an adapter is required to connect the bulb removal/replacement heads 8′, 9′ to the extension pole 7. In accordance with one particular embodiment of the invention, an adaptor 60 is provided which includes an adapter body including an internal/female, right-handed thread 65 and an external/male, left-handed thread 66. The female, right-handed thread 65 is configured to mate with the male, right-handed first threaded end 15 of the extension pole 7. The male, left-handed thread 66 of the adapter 60 is configured to mate with the female, left-handed thread 16′, 33′ of the bulb removal/replacement heads 8′, 9′. Thus, counterclockwise rotation of the extension pole 7 while extracting a bulb, will not unscrew the head 8′,9′ or 10 from the pole 7, but rather, will cause the head 8′, 9′ or 10 to tighten onto the pole 7, via the adapter 60.

In one particular embodiment of the invention, the outside diameter of the female end of the adapter 60 is 1.05 inches and the thread size is 0.29 inches. Additionally, in one embodiment the total length of the adapter 60 is 2.38 inches, while the length of the adapter section including the female thread is 1.35 inches. Further, in one particular embodiment, the wall thickness T1 of the adapter 60 in the area of the male thread is 0.06 inches and the wall thickness T2 of the adapter 60 in the area of the female thread is 0.12 inches. Further still, in one particular embodiment, the male thread 66 is an ACME ¾-5 male, left-handed thread and the female thread 65 is an ACME ¾-5 female right-handed thread. As discussed above, the male, right-handed threads of the threaded end 15 are configured to mate with the female, right-handed thread 65 and the female, left-handed threads 16′, 33′ of the heads 8′, 9′ or 10 are configured to mate with the male, left-handed thread 66 of the adapter 60.

Although the foregoing embodiment of adapter 60 is described as having a male, left-handed thread and a female, right-handed thread, it should be understood that these can be reversed without departing from the spirit of the invention if the male pole thread is left-handed and the head thread is a right-handed thread. Such an embodiment would be particularly useful when screwing in replacement bulbs, rather than extracting them. Additionally, it should be understood that other modifications can be made to the embodiments shown without departing from the scope and spirit of the present invention. Further, as discussed above, the adapter can be used with other types of light bulb installation and removal heads, without being limited only to the particular bulb removal/replacement head or extractor head 8, 8′, 9, 9′ shown. Further still, it can be seen that, if both the extension pole and bulb removal/replacement head have oppositely handed male threads, the adapter can be modified to have two, oppositely handed female threads, instead of a male thread and an oppositely handed female thread, without departing from the scope of the present invention. Similarly, if both the extension pole and the bulb removal/replacement head have oppositely handed female threads, the adapter can be modified to have two, oppositely handed male threads, instead of a male thread and an oppositely handed female thread, without departing from the scope of the present invention.

Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

1. An adapter for a light bulb removal/replacement tool having an extension pole and a bulb removal/replacement head, the adapter comprising:
an adapter body including a first adapter thread at a first end of said adapter body and a second adapter thread at a second end of said adapter body opposite said first end, said second adapter thread oppositely handed from said first thread;
said first adapter thread configured to mate with a thread of the extension pole; and
said second adapter thread configured to mate with a thread of the bulb removal/replacement head.

2. The adapter according to claim 1, wherein said first adapter thread is a female, right-handed thread and said second adapter thread is a male, left-handed thread.

3. The adapter according to claim 2, wherein said first adapter thread is configured to mate with a male thread of the extension pole and said second adapter thread is configured to mate with a female thread of the bulb removal/replacement head, the female thread of the bulb removal/replacement head being oppositely handed from the male thread of the extension pole.

4. A light bulb installation and/or removal tool, comprising:
an extension pole including a pole thread;
a bulb removal/replacement head having a head thread, said head thread oppositely handed from said pole thread;
the adapter according to claim 1.

5. The tool of claim 4, wherein said first adapter thread is a female, right-handed thread and said second adapter thread is a male, left-handed thread.

6. A light bulb installation and/or removal tool, comprising:
an extension pole including a male, right-handed pole thread;
a bulb removal/replacement head having a bulb removing portion and a female, left-handed head thread;
an adapter including a female, right-handed adapter thread configured to mate with said male, right-handed pole thread and a male, left-handed adapter thread configured to mate with said female, left-handed head thread.

7. The tool of claim 6, wherein said bulb removal/replacement head includes an extractor head having a guide defining an outer circumference of said extractor head, said extractor head having a bulb extractor configured for engaging in a base of the broken light bulb and creating a friction connection with the base of the light bulb, said bulb extractor being surrounded by said guide, said guide having a diameter being less than a diameter of a high-hat light fixture and dimensioned so that when the bulb extractor is disposed within the high-hat light fixture said bulb extractor is self-aligned with a middle area of the base of a broken light bulb.

8. The tool according to claim 7, wherein said guide is cylindrically shaped and completely surrounds said bulb extractor.

9. The tool according to claim 7, wherein said bulb extractor has a plurality of blades and a point of intersection of said blades defines a tip for jabbing into the base of the broken light bulb.

10. The tool according to claim 9, wherein each of said blades has a first end tapering towards said second end, and said tip is formed where said second end of said blades meet.

11. A method of extracting a light bulb from a socket of a high-hat light fixture, which comprises the steps of:
providing the adapter according to claim 1;
mating the first thread adapter with the thread of an extension pole;
mating the second thread adapter with a thread of a bulb removal/replacement head, the thread of the extension pole being oppositely handed from the thread of the bulb removal/replacement tool;
using the pole to align the bulb removal/replacement head with the socket of the high-hat light fixture;
engaging at least a portion of a bulb in the socket with the bulb removal/replacement head; and
rotating the extension pole to remove the at least a portion of a bulb from the socket.

12. The method of claim 11, wherein the first adapter thread is a female, right-handed thread and the second adapter thread is a male, left-handed thread.

13. The method of claim 11, wherein the wherein the bulb removal/replacement head includes an extractor head having a guide defining an outer circumference of the extractor head, the extractor head having a bulb extractor configured for engaging in a base of a broken light bulb and creating a friction connection with the base of the broken light bulb, the bulb extractor being surrounded by the guide, the guide having a diameter being less than a diameter of a high-hat light fixture and dimensioned so that when the bulb extractor is disposed within the high-hat light fixture the bulb extractor is self-aligned with a middle area of the base of the broken light bulb.
